(19) United States
(12) Patent Application Publication
(10) Pub. No.: US 2026/0121011 A1
(43) Pub. Date: Apr. 30, 2026

(54) QUADRUPOLE MASS FILTER

(71) Applicant: Thermo Fisher Scientific (Bremen) GmbH, Bremen (DE)

(72) Inventors: Dmitry STRELNIKOV, Heidelberg (DE); Dmitry GRINFELD, Bremen (DE); Jan-Peter HAUSCHILD, Weyhe (DE); Aivaras VENCKUS, Oldenburg (DE); Christian BOEDEKER, Vollersode (DE)

(73) Assignee: Thermo Fisher Scientific (Bremen) GmbH, Bremen (DE)

(21) Appl. No.: 19/369,036

(22) Filed: Oct. 24, 2025

(30) Foreign Application Priority Data
Oct. 25, 2024 (GB) 2415699.4

(51) Int. Cl. H01J 49/42; H01J 49/00; H01J 49/02

(52) U.S. Cl. CPC H01J 49/4215; H01J 49/0009; H01J 49/022

(57) ABSTRACT

A quadrupole mass filter assembly comprises five quadrupole segments. An entrance quadrupole segment is configured to receive RF voltages, a secondary quadrupole segment is arranged downstream of the entrance quadrupole segment and is configured to receive RF and resolving DC voltages. A middle quadrupole segment is arranged downstream of the secondary quadrupole segment and is configured to receive RF voltages. A primary quadrupole segment is arranged downstream of the middle quadrupole segment and is configured to receive RF and resolving DC voltages. An end quadrupole segment is arranged downstream of the primary quadrupole segment and is configured to receive RF voltages.

### CROSS-REFERENCE TO RELATED APPLICATION

This application claims priority from United Kingdom patent application no. GB2415699.4, filed Oct. 25, 2024. The entire disclosure of GB2415699.4 is incorporated herein by reference.

### FIELD

The present disclosure relates to the fields of ion optics and mass spectrometry, and in particular to quadrupole mass filters for use in analytical instruments such as a mass spectrometers.

### BACKGROUND

Quadrupole mass filters in mass spectrometers often suffer from contamination created by ions. This contamination becomes charged when new ions fall on the contaminated areas. This leads to a decrease in performance of the ion optical system. For example, this can lead to a decrease of the transmitted ion current, isolation profile broadening, etc. To solve this problem, it is normally necessary to vent the system and to perform mechanical cleaning of the contaminated areas.

Methods to keep ion optics relatively free from contamination include reducing the exposure time (as described, for example, in U.S. Pat. No. 9,543,131) or deflecting ions to areas where charge accumulation is not as problematic. For example, slits in quadrupole rods can be provided to keep most of the relevant rod's surface clean, as described in UK Patent No. GB 2,555,032. However, a disadvantage of this technique is that geometrical changes of the quadrupole surface may affect (e.g. decrease to some extent) the resolution of the quadrupole.

Another approach is to add additional mass filters or electrodes to a quadrupole, which filter out unwanted species and reduce contamination of the main quadrupole rods. Examples of this approach can be found, for example, in U.S. Pat. Nos. 7,211,788 and 9,929,003. These solutions are known to work, but they still require cleaning of rods, albeit at longer time intervals.

It is believed that there remains scope for improvements to quadrupole mass filters.

### SUMMARY

A first aspect provides a quadrupole mass filter assembly comprising:
an entrance quadrupole segment, wherein the entrance quadrupole segment is configured to receive RF voltages;
a secondary quadrupole segment arranged downstream of the entrance quadrupole segment, wherein the secondary quadrupole segment is configured to receive RF and resolving DC voltages;
a middle quadrupole segment arranged downstream of the secondary quadrupole segment, wherein the middle quadrupole segment is configured to receive RF voltages;
a primary quadrupole segment arranged downstream of the middle quadrupole segment, wherein the primary quadrupole segment is configured to receive RF and resolving DC voltages; and
an end quadrupole segment arranged downstream of the primary quadrupole segment, wherein the end quadrupole segment is configured to receive RF voltages.

Embodiments provide a quadrupole mass filter formed from five quadrupole segments. This is in contrast with standard quadrupole mass filters which are commonly formed from three segments: a central resolving quadrupole surrounded by RF-only pre- and post-quadrupole segments. In accordance with embodiments, two additional segments have been added to the conventional three-segment quadrupole: a short resolving pre-quadrupole and a short focusing middle RF-only segment. The additional resolving pre-quadrupole has a lower resolution capability than the main resolving quadrupole, and so it is less sensitive to contamination. The main resolving quadrupole is not contaminated as fast as in the case of a conventional three-segment quadrupole.

It will accordingly be appreciated that embodiments provide an improved quadrupole mass filter.

The entrance quadrupole segment, the secondary quadrupole segment, the middle quadrupole segment, the primary quadrupole segment, and the end quadrupole segment may be assembled together into a single assembly. Each pair of adjacent quadrupole segments may be spaced apart (along an axial (z) direction) by a spacing that has a length (along the axial (z) direction) less than or equal to 2 mm.

The primary quadrupole segment has a first length (along the axial (z) direction) and the secondary quadrupole segment has a second length (along the axial (z) direction) that may be less than the first length.

The first length may be greater than or equal to 15r₀, where r₀ is an inscribed radius of each of the quadrupole segments (including the primary quadrupole segment). The second length may be greater than or equal to 5r₀ and/or less than or equal to 10r₀.

The middle quadrupole segment has a third length (along the axial (z) direction) that may be less than or equal to 5r₀. The third length may be greater than or equal to 2r₀.

The entrance quadrupole segment has a fourth length (along the axial (z) direction) that may be greater than or equal to 2r₀ and/or less than or equal to 5r₀. The end quadrupole segment has a fifth length (along the axial (z) direction) that may be greater than or equal to 2r₀ and/or less than or equal to 5r₀.

The assembly may form part of a quadrupole mass filter. Thus, according to another aspect, there is provided a quadrupole mass filter comprising the assembly described above.

The quadrupole mass filter may comprise:
one or more RF voltage power supplies configured to supply RF voltages to the entrance quadrupole segment, the secondary quadrupole segment, the middle quadrupole segment, the primary quadrupole segment, and the end quadrupole segment; and
one or more DC voltage power supplies configured to supply resolving DC voltages to the primary quadrupole segment and to the secondary quadrupole segment.

The quadrupole mass filter may be configured such that an amplitude of an RF voltage supplied to the middle quadrupole segment is between about 30% and 150% of an amplitude of an RF voltage supplied to the primary quadrupole segment.

The quadrupole mass filter may be configured such that the primary quadrupole segment and the secondary quadrupole segment are supplied with RF voltages by the same single RF power supply.

The quadrupole mass filter may comprise one or more DC voltage power supplies configured to supply respective DC offset voltages to the primary quadrupole segment and the secondary quadrupole segment, and optionally to the entrance quadrupole segment, the middle quadrupole segment and the end quadrupole segment.

The quadrupole mass filter may be configured to decrease a magnitude of a DC offset voltage applied to the secondary quadrupole segment during operation to maintain a kinetic energy of the ions as contamination of the secondary quadrupole segment produces an increasing potential barrier.

The quadrupole mass filter may be configured such that ions are received by the secondary quadrupole segment with a first average oscillation amplitude and are received by the primary quadrupole segment with a second average oscillation amplitude. The second average oscillation amplitude may be at least 1.15 times the first average oscillation amplitude. The second average oscillation amplitude may be at least 1.5 times, at least 2 times, or at least 3 times the first average oscillation amplitude.

The quadrupole mass filter may form part of an analytical instrument such as a mass spectrometer. Thus, according to another aspect, there is provided an analytical instrument comprising an ion source configured to generate ions and the quadrupole mass filter described above.

The analytical instrument may be configured such that the quadrupole mass filter receives at least some of the ions generated by the ion source and/or receives ions derived from ions generated by the ion source, and the quadrupole mass filter may be configured to transmit at least some of the received ions.

According to another aspect, there is provided a method of calibrating voltages to be applied to the quadrupole mass filter described above. The method may comprise:
(i) operating the secondary quadrupole segment in an RF-only mode and calibrating the primary quadrupole segment to obtain calibrated resolving DC voltage amplitudes and RF voltage amplitudes for the primary quadrupole segment for each of a plurality of different mass to charge ratio (m/z) transmission windows; and
(ii) obtaining calibrated resolving DC voltage amplitudes for the secondary quadrupole segment for each of the plurality of different mass to charge ratio (m/z) transmission windows by:
for each mass to charge ratio (m/z) transmission window of some of all of the plurality of different mass to charge ratio (m/z) transmission windows: operating the primary quadrupole segment with the resolving DC voltage amplitude and RF voltage amplitude obtained from step (i) for that transmission window and adjusting the resolving DC voltage amplitude applied to the secondary quadrupole segment so as to increase and/or maximise ion transmission through the quadrupole mass filter.

The method may further comprise:
(iii) adjusting DC offset voltage(s) applied to the primary quadrupole segment and/or to the secondary quadrupole segment to obtain suitable isolation window shapes and ion transmission; and then
(iv) repeating steps (i) and (ii) so as to fine tune the resolving DC voltage amplitudes.

According to another aspect, there is provided a method of operating a quadrupole mass filter that comprises:
an entrance quadrupole segment, a secondary quadrupole segment arranged downstream of the entrance quadrupole segment, a middle quadrupole segment arranged downstream of the secondary quadrupole segment, a primary quadrupole segment arranged downstream of the middle quadrupole segment, and an end quadrupole segment arranged downstream of the primary quadrupole segment;
the method comprising:
applying RF voltages to the entrance quadrupole segment;
applying RF and resolving DC voltages to the secondary quadrupole segment;
applying RF voltages to the middle quadrupole segment;
applying RF and resolving DC voltages to the primary quadrupole segment; and
applying RF voltages to the end quadrupole segment.

The entrance quadrupole segment, the secondary quadrupole segment, the middle quadrupole segment, the primary quadrupole segment, and the end quadrupole segment may be assembled together into a single assembly, with spacings between adjacent quadrupole segments having a length less than or equal to 2 mm.

The primary quadrupole segment has a first length (along the axial (z) direction). The secondary quadrupole segment has a second length (along the axial (z) direction) that may be less than the first length and that may be greater than or equal to 5r₀, where r₀ is an inscribed radius of each quadrupole segment including the primary quadrupole segment. The middle quadrupole segment has a third length (along the axial (z) direction) that may be less than or equal to 5r₀.

An amplitude of the RF voltage supplied to the middle quadrupole segment may be between 30% and 150% of an amplitude of the RF voltage supplied to the primary quadrupole segment.

The method may comprise the quadrupole mass filter receiving ions and filtering them according to their mass to charge ratio (m/z).

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

Any of the aspects and embodiments described above can, and in embodiments do, include any one or more or each of the optional features described herein.

### BRIEF DESCRIPTION OF THE DRAWINGS

Various embodiments will now be described in more detail with reference to the accompanying Figures, in which:

FIG. 1 shows schematically a mass spectrometer in accordance with embodiments.

FIG. 2 shows schematically a quadrupole mass filter assembly in accordance with embodiments.

FIG. 3 shows schematically detail of a quadrupole mass filter assembly in accordance with embodiments.

FIG. 4 shows schematically a quadrupole mass filter in accordance with embodiments.

FIG. 5 shows schematically detail of a power supply for a quadrupole mass filter in accordance with embodiments.

FIG. 6A shows schematically an example ion trajectory through a quadrupole mass filter in accordance with embodiments.

FIG. 6B shows schematically an example ion trajectory through two conventional “3S-Quads” arranged in series.

FIG. 7 shows schematically a quadrupole mass filter assembly comprising only four segments (a “4S-Quad”).

FIG. 8A shows ion optical simulation of ion trajectories through a 4S-Quad.

FIG. 8B shows ion optical simulation of ion trajectories through a 5S-quad.

FIG. 9A shows an example RF voltage amplitude/resolving DC voltage scan for the main quadrupole of a 5S-quad for m/z 195.

FIG. 9B shows an example RF voltage amplitude/resolving DC voltage scan for the pre-quadrupole of a 5S-quad for m/z 195.

FIG. 10A shows a simulated heatmap of ion transmission for ions with m/z 195 for various main quadrupole and pre-quadrupole DC offset voltage magnitudes.

FIG. 10B shows a simulated heatmap of ion transmission for ions with m/z 1922 for various main quadrupole and pre-quadrupole DC offset voltage magnitudes.

### DETAILED DESCRIPTION

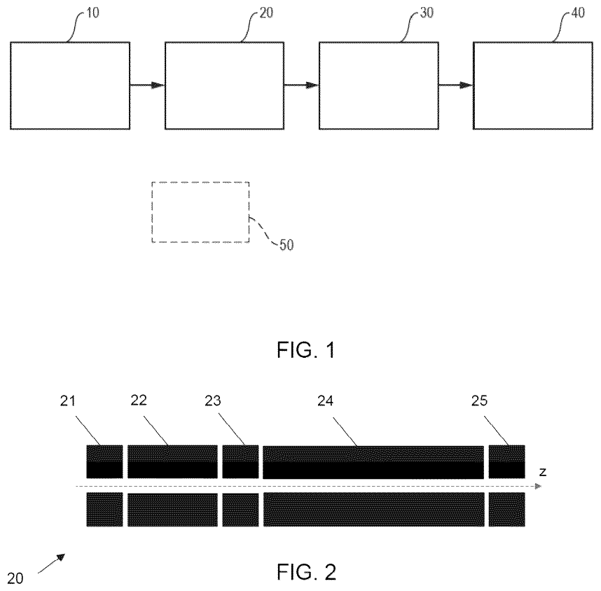

FIG. 1 illustrates schematically an analytical instrument, such as a mass spectrometer, that may include the quadrupole mass filter as described herein. As shown in FIG. 1, the instrument includes an ion source 10, a quadrupole mass filter 20, a fragmentation device 30, and a mass analyser 40.

The ion source 10 is configured to generate ions from a sample. The ion source 10 may be coupled to a separation device (not shown) such as a liquid chromatography (LC) separation device, a gas chromatography (GC) separation device, or a capillary electrophoresis separation device, and the like, such that the sample which is ionised in the ion source 10 comes from the separation device. The ion source 10 can be any suitable ion source, such as an electrospray ionisation (ESI) ion source, an atmospheric pressure ionisation (API) ion source, a chemical ionisation ion source, an electron impact (EI) ion source, or similar. Numerous other types of ionisation are possible.

The analytical instrument may additionally or alternatively include an ion separation device (not shown) arranged downstream of the ion source and configured to separate samples ions according to a physico-chemical property. For example, the instrument may include an ion mobility (IM) separator, a differential ion mobility separator, or a device configured to separate ions according to their mass to charge ratio (m/z)).

The quadrupole mass filter 20 is arranged downstream of the ion source 10 and is configured to receive ions from the ion source 10 (optionally via the ion separation device). The quadrupole mass filter 20 is configured to filter the received ions according to their mass to charge ratio (m/z). The quadrupole mass filter 20 may be configured such that received ions having m/z within an m/z transmission window (or “isolation window”) of the mass filter are onwardly transmitted by the mass filter, while received ions having m/z outside the m/z transmission window are attenuated by the mass filter, i.e. are not onwardly transmitted by the mass filter. The width and/or the centre m/z of the transmission window may be controllable (variable), e.g. by suitable control of RF and/or DC voltage(s) applied to electrodes of the quadrupole mass filter 20. Thus, for example, the quadrupole mass filter 20 may be operable in a transmission mode of operation, whereby most or all ions within a relatively wide m/z window are onwardly transmitted by the mass filter 20, and a filtering mode of operation, whereby only ions within a relatively narrow m/z window (centred at a desired m/z) are onwardly transmitted by the mass filter 20.

The fragmentation device 30 is arranged downstream of the quadrupole mass filter 20 and is configured to receive most or all ions transmitted by the mass filter 20. The fragmentation device 30 may be configured to selectively fragment some or all of the received ions, i.e. so as to produce fragment ions. The fragmentation device 30 may be operable in a fragmentation mode of operation, whereby most or all received ions are fragmented so as to produce fragment ions (which may then be onwardly transmitted from the fragmentation device 30), and a non-fragmentation mode of operation, whereby most or all received ions are onwardly transmitted without being (deliberately) fragmented. It would also be possible for a non-fragmentation mode of operation to be implemented by causing ions to bypass the fragmentation device 30. The fragmentation device 30 may also be operable in one or more intermediate modes of operation, e.g. whereby the degree of fragmentation is controllable (variable). The fragmentation device 30 can also be operable in higher order (MSN) fragmentation modes of operation, e.g. whereby fragment ions are further fragmented one or more times by the fragmentation device 30.

The fragmentation device 30 can be any suitable type of fragmentation device, such as for example a collision induced dissociation (CID) fragmentation device, an electron induced dissociation (EID) fragmentation device, a photodissociation fragmentation device, and so on. Numerous other types of fragmentation are possible.

The mass analyser 40 is arranged downstream of the fragmentation device 30 and is configured to receive ions from the fragmentation device 30. Thus, the mass analyser 40 may receive unfragmented precursor ions and/or fragment ions, depending on the mode of operation of the fragmentation device 30. The mass analyser 40 is configured to analyse the received ions so as to determine their mass to charge ratio (m/z) and/or mass, i.e. to produce a mass spectrum of the ions. The mass analyser 40 can be any suitable type of mass analyser, such as an ion trap mass analyser, an electrostatic orbital trap mass analyser (such as an Orbitrap™ FT mass analyser as made by Thermo Fisher Scientific), a time-of-flight (ToF) mass analyser such as a multi-reflecting time-of-flight (MR-ToF) mass analyser, or a quadrupole mass analyser. Numerous other types of mass analyser are possible.

It should be noted that FIG. 1 is merely schematic, and that the instrument can, and in embodiments does, include any number of one or more additional components such as ion optical devices. For example, the instrument may include one or more ion transfer stage(s) arranged between any of the illustrated components, e.g. including an atmospheric pressure interface and/or one or more ion guides, lenses and/or other ion optical devices configured such that some or all of the ions can be transmitted appropriately through the instrument. The ion transfer stage(s) may include any suitable number and configuration of ion optical devices, for example optionally including one or more ion guides, lenses and/or other ion optical devices.

In some embodiments, the instrument may include more than one mass analyser. For example, the instrument may be a dual mass analyser hybrid mass spectrometer of the type described in EP 3,410,463, the contents of which are incorporated herein by reference.

As also shown in FIG. 1, the instrument is under the control of a control unit 50, such as an appropriately programmed computer, which controls the operation of various components of the instrument and, for example, sets the voltages to be applied to the various components of the instrument. The control unit 50 may also receive and process data from various components including the analyser(s).

The instrument may be operable in various mode of operation. In particular, the instrument may be a tandem mass spectrometer operable in an MS1 mode of operation and an MS2 mode of operation.

In the MS1 (or “full mass scan”) mode of operation, the quadrupole mass filter 20 is operated in its transmission mode of operation and the fragmentation device 30 is operated in its non-fragmentation mode of operation, e.g. so that a wide m/z range (e.g. full mass range) of unfragmented (“precursor” or “parent”) ions are analysed by the analyser 40 to produce an MS1 spectrum.

In the MS2 mode of operation, the quadrupole mass filter 20 is operated in its filtering mode of operation and the fragmentation device 30 is operated in its fragmentation mode of operation, e.g. so that a selected narrow m/z range of precursor ions are fragmented and the resulting fragment (“product” or “daughter”) ions are analysed by the analyser 40 to produce an MS2 spectrum.

The instrument may also be operable in one or more higher order fragmentation modes of operation, such as for example an MS3 mode of operation, whereby precursor ions are fragmented, at least some of the resulting fragment ions are themselves fragmented, and the second-generation fragment ions (“granddaughter ions”) are analysed by the analyser 40 produce an MS3 spectrum. In general, the instrument may be operable in any order of fragmentation mode of operation, i.e. in an MSN mode of operation where N≥2.

It should be noted that the instrument depicted in FIG. 1 is merely one example, and that many other analytical instrument configurations and geometries that include a quadrupole mass filter are possible. For example, the mass analyser 40 may include a quadrupole mass filter which may be configured in accordance with embodiments (e.g. in the case of a so-called “triple-quad” mass spectrometer).

As described above, embodiments are directed to a new design of quadrupole mass filter. Quadrupole mass filters commonly suffer from contamination created by ions, and this contamination becomes charged when new ions fall on the contaminated areas, leading to a decrease in performance. To solve this problem, it is normally necessary to vent the system and to perform mechanical cleaning of the contaminated areas.

Standard quadrupole mass filters are typically formed from three segments (“3S-Quad”): a central resolving quadrupole surrounded by RF-only pre- and post-quadrupole segments.

In accordance with embodiments, two additional segments have been added to the conventional three-segment quadrupole: a short resolving pre-quadrupole and a short focusing middle RF-only quadrupole segment. The additional resolving pre-quadrupole has a lower resolution capability than the main resolving quadrupole, and so it is less sensitive to contamination. The main resolving quadrupole is not contaminated as fast as in the case of a conventional 3S-Quad.

A “5S-Quad” in accordance with embodiments is shown schematically in FIG. 2. As described above, the quadrupole mass filter 20 is configured to receive ions at an entrance at one end of the mass filter, and to transmit at least some of the received ions to an exit at the other end of the mass filter (optionally while filtering the received ions according to their mass to charge ratio (m/z)). Ions are transmitted through the quadrupole mass filter 20 from the entrance to the exit generally in an axial (z) direction (indicated by the dashed arrow in FIG. 2). As such, as used herein, the terms “downstream” and “upstream” are defined relative to the general direction of the flow of ions through the quadrupole mass filter 20.

As shown in FIG. 2, the quadrupole mass filter assembly comprises five quadrupole segments 21, 22, 23, 24, 25. The five quadrupole segments include a primary quadrupole segment 24 and a secondary quadrupole segment 22 arranged upstream of the primary quadrupole segment 24, with a middle quadrupole segment 23 arranged between the primary quadrupole segment 24 and the secondary quadrupole segment 22. An entrance quadrupole segment 21 and an end quadrupole segment 25 are respectively provided at the entrance and exit ends of the quadrupole mass filter assembly.

Each quadrupole segment comprises four rod electrodes which surround a central axis of the quadrupole mass filter (i.e. which is arranged along the axial (z) direction). Each rod electrode is generally elongated along the axial (z) direction and may have any suitable cross-sectional shape such as a circular or hyperbolic cross-sectional shape. In each segment, the four rod electrodes are arranged parallel to one another, and parallel to the axial (z) direction.

Each rod electrode of each segment is axially aligned with each corresponding rod electrode of each of the other segments, i.e. so that the overall quadrupole assembly is, in effect, formed from four segmented rod electrodes, with each segmented rod electrode being segmented into five segments along the axial (z) direction.

In embodiments, the primary quadrupole segment 24, being the main resolving quadrupole segment, has a length (in the axial (z) direction) which is greater than the lengths of the other segments. The secondary quadrupole segment 22, which is also a resolving quadrupole segment, has a length that is greater than the lengths of the entrance 21, middle 23 and end 25 segments, but that is less than the length of the primary quadrupole segment 24. As such, the secondary quadrupole segment 22 has a lower resolution capability than the primary quadrupole segment 24.

All five quadrupole segments are machined and assembled into one unit. That is, the entrance quadrupole segment 21, the secondary quadrupole segment 22, the middle quadrupole segment 23, the primary quadrupole segment 24, and the end quadrupole segment 25 are all assembled together into a single assembly, i.e. before the resulting assembly is installed into the analytical instrument (mass spectrometer). The electrodes of the quadrupole require very precise alignment, and so this allows high performance of the quadrupole mass filter to be maintained while also saving space.

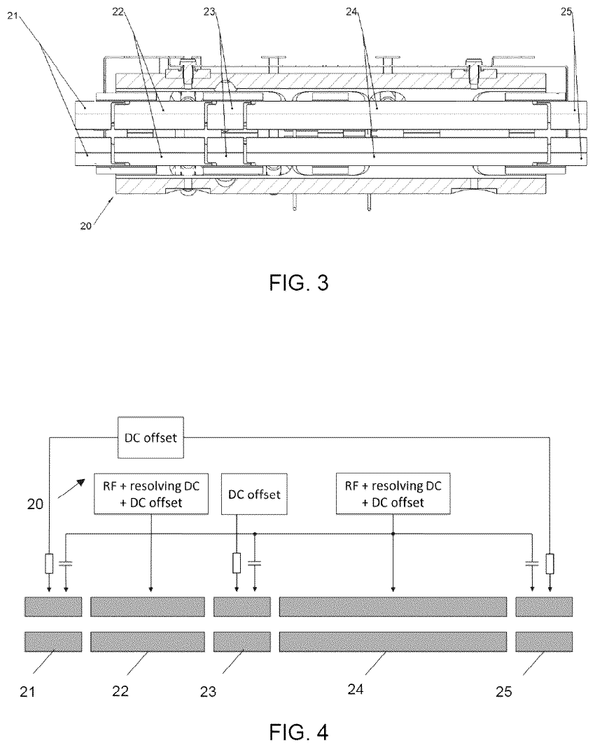

FIG. 3 illustrates schematically the resulting quadrupole mass filter assembly, where the various segments have been assembly together into a single assembly that includes appropriate support structures and electrically connections for each of the electrodes. This unit is assembled independently before being installed into the analytical instrument (mass spectrometer).

In operation, RF and/or DC voltages are applied to the electrodes of each segment such that ions having m/z values within a desired m/z range assume stable trajectories (i.e. are radially confined while being axially transmitted) through the quadrupole mass filter and are transmitted to the exit. Ions having m/z values outside of the desired m/z range assume unstable trajectories in the quadrupole mass filter and are lost and/or substantially attenuated without being transmitted to the exit. The quadrupole mass filter comprises RF and DC voltage power supplies configured to supply the quadrupole segments with the various RF and DC voltages.

Ions are confined radially within each segment by a radial pseudo-potential barrier, which is created by applying RF voltages to the electrodes of that segment. In each segment, each pair of opposing electrodes may be electrically connected and/or provided with the same RF voltage. A first phase of the RF voltage is applied to one of the pairs of opposing electrodes, and the opposite phase of the RF voltage (180° out of phase) is applied to the other pair of opposing electrodes. The amplitude and frequency of the RF voltage(s) are selected as desired to achieve suitable ion transmission. The frequency of the RF voltages applied to each of the segments should be the same, whereas the amplitudes can be the same or different.

In addition to the RF voltages, DC voltages may be applied to some of the electrodes of the quadrupole mass filter. In particular, resolving DC voltages may be applied to each of the resolving quadrupole segments 22, 24. That is, for one or both of the resolving quadrupole segments, an attractive DC voltage may be applied to one pair of opposing electrodes and a repulsive DC voltage may be applied to the other pair of opposing electrodes. The attractive and repulsive DC voltages impose a mass cut-off to the range of ion m/z that can pass through the quadrupole segment.

Each segment of the quadrupole mass filter may also receive a respective DC offset voltage. A DC offset voltage can be applied to each segment in order to control the kinetic energy of ions as they travel through the quadrupole mass filter 20. In embodiments, the resolving DC voltages and the DC offset voltages can be set independently.

Thus, as illustrated by FIG. 4, the primary quadrupole segment 24 is a resolving quadrupole, and so is configured to receive both RF and resolving DC voltages, optionally together with a respective DC offset voltage. Similarly, the secondary quadrupole segment 22 is a resolving quadrupole and so is configured to receive RF and resolving DC voltages, optionally together with a respective DC offset voltage.

The entrance quadrupole segment 21, which is provided immediately upstream of the secondary quadrupole segment 22, is an RF-only quadrupole segment, and so is configured to receive RF voltages optionally together with a respective DC offset voltage (and is not configured to receive resolving DC voltages). Similarly, the end quadrupole segment 25, which is arranged immediately downstream of the primary quadrupole segment 24, is an RF-only quadrupole segment, and so is configured to receive RF voltages optionally together with a respective DC offset voltage (and is not configured to receive resolving DC voltages). The middle quadrupole segment 23, which is arranged immediately downstream of the secondary quadrupole segment 22 and immediately upstream of the primary quadrupole segment 24, is also an RF-only quadrupole segment, and so is configured to receive RF voltages optionally together with a respective DC offset voltage (and is not configured to receive resolving DC voltages).

In embodiments, the primary quadrupole segment 24 and the secondary quadrupole segment 22 are provided with their RF voltages by the same RF power supply. The RF-only segments may also be provided with their RF voltages by the said same RF power supply. Advantageously, the 5S-Quad does not need an additional RF unit in comparison to a conventional 3S-Quad.

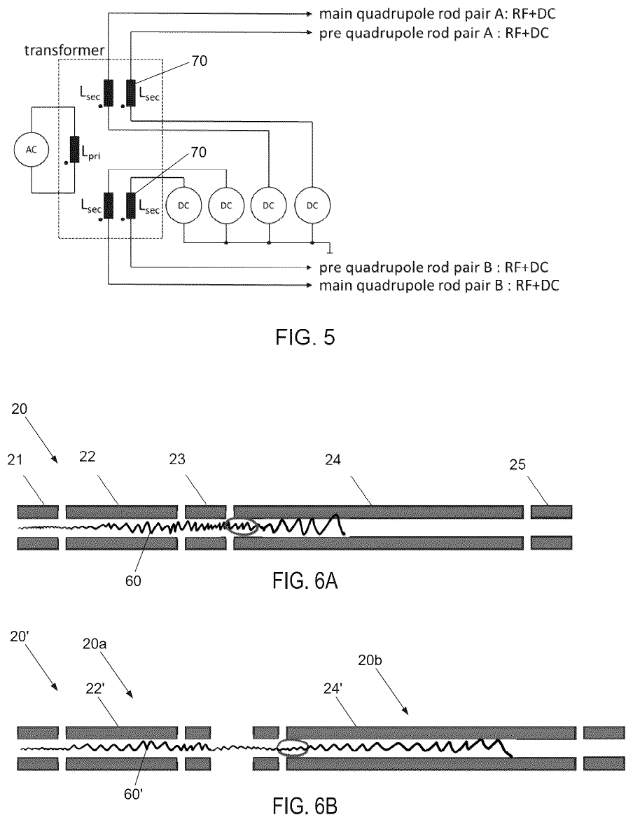

For proper ion transmission, it is beneficial to provide the same RF phase to all of the segments. In addition, the amplitude of the RF voltages provided to the main 24 and pre-quad 22 segments should be similar or equal. As illustrated by FIG. 5, this can be achieved by adding additional secondary coils 70 to the transformer. Using capacitors would lead to problems with precision, resonance and fast switching of resolving DCs.

Thus, as shown in FIG. 5, in embodiments one transformer is used to provide the RF voltages to both the pre-quadrupole 22 and the main quadrupole 24 segments. The transformer has two secondary windings. An RF (AC) voltage generator is coupled to the primary winding of the transformer, the electrodes of the primary quadrupole segment 24 are coupled to one of the secondary windings of the transformer, and the electrodes of the secondary quadrupole segment 22 are coupled to the other secondary winding of the transformer.

In embodiments, the quadrupole mass filter 20 is configured such that ions do not “forget” the time spent in the pre-quadrupole 22 and enter the main resolving quadrupole 24 with relatively large oscillation amplitudes. Advantageously, this allows the resolution performance of the quadrupole mass filter to be maintained despite the length of the main resolving segment 24 being shortened due to the other segments.

To achieve this, various parameters of the quadrupole mass filter have been carefully optimised by performing simulations with the MASIM simulation package.

The length of the middle segment 23 should be less than or equal to 5r₀, where r₀ is the inscribed radius of the quadrupole (i.e. the inscribed radius of the polygon defined by the radially innermost surfaces of the rod electrodes). The length of the middle segment 23 should be larger than or equal to 2r₀. For example, the length of the middle segment 23 may be approximately equal to 3r₀.

The amplitude of the RF voltage applied to the middle segment 23 should be between 30% and 150% of the amplitude of the RF voltage applied to the main quadrupole segment 24, such as between about 50% and 100%, e.g. around 75%, of the amplitude of the RF voltage applied to the main quadrupole segment 24.

The length of the secondary quadrupole segment 22 should be larger than or equal to 5r₀. The length of the secondary quadrupole segment 22 can be as long as the primary quadrupole segment 22 or longer. Where, however, there is a total length limitation for the quadrupole assembly, the secondary quadrupole segment 22 may be as short as possible. Thus, the length of the secondary quadrupole segment 22 may be less than or equal to 10r₀. For example, the secondary quadrupole segment 22 may have a length approximately equal to 7.5r₀.

In addition, the separation distance (in the axial (z) direction) between the rod electrodes of adjacent segments should be 2 mm (or less). That is, the separation (in the axial (z) direction) between one or more or each of (i) the entrance quadrupole segment 21 and the secondary quadrupole segment 22; (ii) the secondary quadrupole segment 22 and the middle quadrupole segment 23; (iii) the middle quadrupole segment 23 and the primary quadrupole segment 24; and (iv) the primary quadrupole segment 24 and the end quadrupole segment 25, should be less than or equal to 2 mm.

Where there is a total length limitation for the quadrupole assembly, the entrance segment 21, the pre-quadrupole 22, the middle segment 23, and the end segment 25 should be made as short as possible, to avoid excessive shortening of the main quadrupole segment 24 (and to increase and/or maximise its resolution capability).

The lengths of the entrance 21 and end 25 segments should be larger than or equal to 2r₀ (but less than or equal to 5r₀). In some embodiments, the lengths of the entrance 21, middle 23 and end 25 segments are approximately equal. For example, the lengths of the entrance 21, middle 23 and end 25 segments may be approximately equal to 3r₀. Other lengths are possible.

The length of the primary quadrupole segment 24 may be equal to the maximum available length, i.e. the total length of the quadrupole assembly minus the lengths of the entrance 21, secondary 22, middle 23 and end 25 segments (and minus the lengths of the spacings between the segments). The primary quadrupole segment 24 should be as long as possible. Thus, the primary quadrupole segment 24 may have a length greater than or equal to 15r₀, such as greater than or equal to 20r₀. In particular embodiments, the primary quadrupole segment 24 has a length approximately equal to 25r₀. Other lengths are possible.

The specific configuration of the 5S-Quad ensures that the resolution performance of the quadrupole mass filter is maintained despite the length of the main resolving segment 24 being shortened due to the other segments, because ions do not “forget” the time spent in the pre-quadrupole 22 and enter the main resolving quadrupole 24 with relatively large oscillation amplitudes.

This is illustrated by FIGS. 6A-6B. FIG. 6A illustrates schematically the quadrupole mass filter 20 according to embodiments, while FIG. 6B illustrates schematically a quadrupole mass filter 20′ formed from two regular three-segmented quadrupole mass filters 20a and 20b arranged in series. Both FIG. 6A and FIG. 6B show schematically example trajectories 60 and 60′, respectively, of an ion that has an undesired m/z which is to be filtered out by the quadrupole mass filter.

It can be seen that the ion in FIG. 6B effectively “forgets” the time spent in the pre-quadrupole 22′ and enters the main resolving quadrupole 24′ with a relatively small oscillation amplitude (as indicated by the circled part of the example ion trajectory 60′). Thus, if one were to take an auxiliary sacrificial quadrupole and add an arbitrary RF-only quadrupole to the next analyser quadrupole, ions would enter the analyser quadrupole without being pre-excited in the auxiliary quadrupole, and so one would need a long enough main quadrupole to filter out undesired ions.

In contrast, the ion in FIG. 6A does not “forget” the time spent in the pre-quadrupole 22 and enters the main resolving quadrupole 24 with a relatively large oscillation amplitude (as indicated by the circled part of the example ion trajectory 60). In other words, ions are received by the secondary quadrupole segment with a first average oscillation amplitude and are received by the primary quadrupole segment with a second average oscillation amplitude, where the second average oscillation amplitude is at least 15% higher than the first average oscillation amplitude, such as at least 50%, 100%, 200% or 300% higher than the first average oscillation amplitude.

This is because the function of the additional RF-only segment 23 is not merely to improve the transmission (and indeed, ions would be transmitted well without it (at least for a clean quadrupole)). Instead, the additional RF-only middle segment 23 of the 5S-Quad is configured to focus ions a little to avoid contamination of the main quadrupole 24 entrance. At the same time, it is short enough (≤5r) that the ion beam diameter remains relatively large at the main quadrupole 24 entrance. Furthermore, the 5S-Quad is not merely two quadrupole filters, it is one single unit with a small spacing (≤2 mm) between segments. As a result, the prefiltered unwanted ions, which enter the main quadrupole 24, do not need the same length of the resolving quadrupole 24 (as would be the case in a 3S-Quad, as shown in FIG. 6B) to be filtered out. This maintains the performance of the 5S-Quad despite the shorter length of the main quadrupole 24 similar to that of a 3S-Quad with the same overall length.

Prototypes of the 5S-Quad have been manufactured and tested using an Orbitrap Exploris™ 480 Mass Spectrometer. The lengths of the RF only segments 21, 23, 25, the pre-quadrupole 22 and the main quadrupole 24 were 3r₀, 7.5r₀ and 25r₀, respectively, where r₀=4 mm is inscribed radius of the hyperbolic quadrupole. The 5S-Quad passed all specifications required for a standard 3S-Quad.

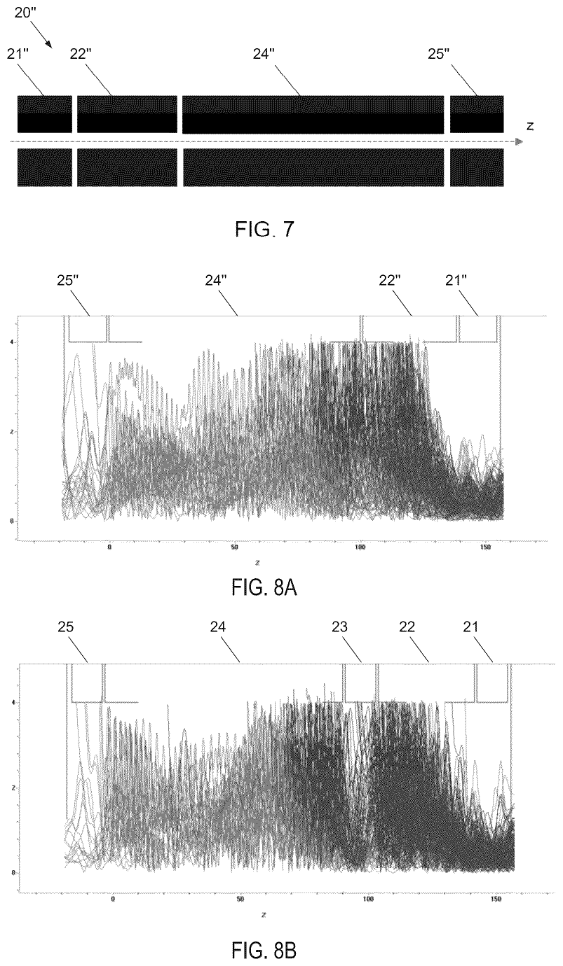

On the way to the 5S-Quad design described herein, a four-segment version of the quadrupole (“4S-Quad”) was tested without a middle focusing RF segment. This is illustrated schematically by FIG. 7. Specifically, FIG. 7 illustrates a quadrupole mass filter 20″ that includes an entrance segment 21″, a secondary quadrupole segment 22″, a primary quadrupole segment 24″, and an end quadrupole segment 25″.

Robustness experiments were conducted using ubiquitin and by monitoring the quadrupole performance over time. It was determined that isolation profile broadening and transmission decrease for a 4S-Quad begins earlier in comparison to a standard 3S-Quad. It is thought that this is due to the interface between the adjacent pre-quadrupole 22 and main quadrupole 24 scattering ions when the entrance of the main quadrupole 24 is contaminated. The additional RF-only focusing segment 23 in the 5S-Quad solves this problem.

The difference in ion trajectories in a 4S-Quad and a 5S-Quad can be seen in FIGS. 8A-8B. FIG. 8A shows the results of ion optical simulations of ion trajectories in a 4S-Quad (e.g., the quadrupole mass filter 20), while FIG. 8B shows the results of ion optical simulations of ion trajectories in a 5S-Quad (e.g., the quadrupole mass filter 20″). The quadrupole entrance is on the right-hand side, and the exit is on the left-hand side.

In FIGS. 8A and 8B, ions fly from the right to the left. Looking at the primary quadrupole segment 24″ entrance of the 4S-Quad in FIG. 8A, it can be seen that many ions hit the interface area between the secondary quadrupole 22″ and the primary quadrupole 24″, especially the entrance edge of the primary quadrupole 24″. This area will charge up, scatter ions and create a potential barrier. Looking at the 5S-Quad in FIG. 8B, there is a soft transition between the secondary quadrupole 22 and the primary quadrupole 24. Ions do not hit the entrance edge of the primary quadrupole 24 and are transferred further.

In robustness experiments, the contamination stripe on the main segment of the 5S-quad starts away from the entrance, which fits to the theoretical simulations.

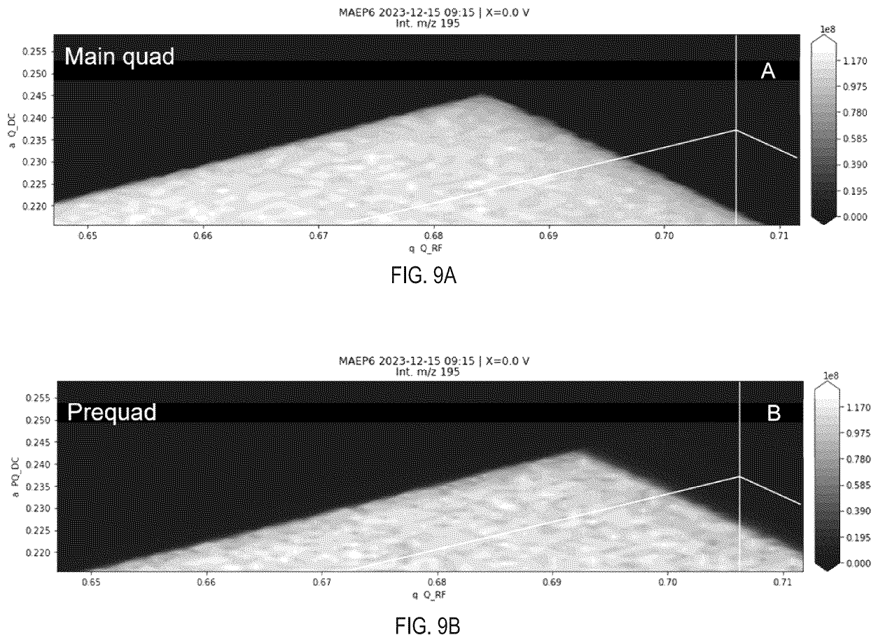

Various measurements for characterization of a 5S-Quad were performed. To understand how the pre-quadrupole 22 (PQ) and main quadrupole 24 (MQ) transmit ions, the RF voltage amplitudes and the magnitudes of the resolving DC voltages applied to the PQ and MQ were scanned. Examples of such scans for m/z 195 are shown in FIGS. 9A-9B.

For the main quadrupole measurement (FIG. 9A), the pre-quadrupole 22 was operating in RF-only mode. The pre-quad scan (FIG. 9B) was done with the main quadrupole 24 operating in RF only mode. The white lines indicate Mathieu's theoretical limits of the transmission region.

The variables q and a represent the RF and resolving DC components, and are derived as:

$$q = \frac{4 e * A m {p}_{R F}}{{mr}_{0}^{2} {ω}^{2}} , and$$

$$a = \frac{8 e * r e s D C}{{mr}_{0}^{2} {ω}^{2}} ,$$

where e is the elementary charge, Amp_{RF} is the RF amplitude, resDC is the magntidue of the resolving DC voltage, m is the mass of ion, r₀ is the inscribed radius of the hyperbolic quadrupole, and ω is the RF angular frequency.

It can be seen that the apex positions slightly differ for the pre-quadrupole and the main quadrupole, despite the same inscribed r₀-4 mm for both resolving segments. This is due to the different lengths of the segments and slightly different RF amplitudes. This should be taken into an account by properly adjusting the resolving DC voltages when both resolving segments are operating in m/z filtering mode. The deviations of the experimental apex positions from the theoretical ones may originate from insufficiently accurate readbacks of the RF amplitudes.

In operation, the quadrupole mass filter may be configured such that corresponding RF and resolving DC voltages are applied to the primary quadrupole segment 24 and to the secondary quadrupole segment 22, i.e. so that the m/z isolation windows of the pre-quadrupole 22 and the main quadrupole 24 segments are substantially aligned. The pre-quadrupole 22 has a lower resolution than the main quadrupole 24 segment, and so will always transmit a broader m/z range of ions than the main quadrupole 24.

During normal operation of the 5S-Quad, the following relationship can be used:

$$r e s D {C}_{P Q} = k ( m / z , iso width ) * {resDC}_{M Q} .$$

The function k can be derived from calibration measurements and targets the highest transmission and possibly the narrowest pre-quadrupole isolation width. Another possibility is to operate the 5S-Quad with k=1. This will affect the isolation profile shapes but will simplify the driving electronics.

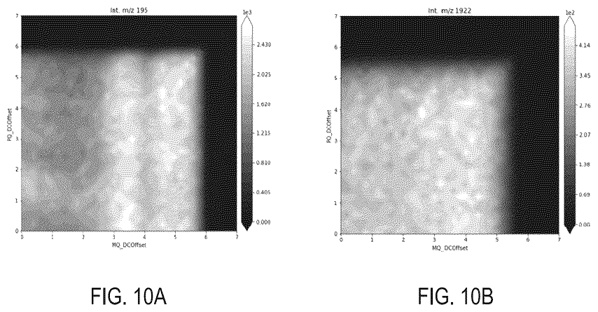

In order to find out which pre-quadrupole DC offsets should be applied, the transmission of ions was measured for different main quadrupole and pre-quadrupole DC offset voltages. This is illustrated by FIGS. 10A-10B. Specifically, FIG. 10A shows a simulated heatmap of ion transmission for ions with m/z 195 for various main quadrupole and pre-quadrupole DC offset voltage magnitudes, while FIG. 10B shows a simulated heatmap of ion transmission for ions with m/z 1922 for various main quadrupole and pre-quadrupole DC offset voltage magnitudes.

To maintain the performance of the 5S-Quad, a zero pre-quadrupole DC offset should be applied, or the pre-quadrupole DC offset should be continuously decreased during operation to compensate for potential created by charged contamination.

In the first approach, an accelerating DC offset is applied to the pre-quadrupole and is kept constant until the quadrupole requires cleaning. The kinetic energy of ions in the pre-quadrupole will be maximal at the beginning for a clean quadrupole and will decrease with time because of contamination.

In the second approach, the pre-quadrupole DC offset is continuously decreased during operation to compensate for the potential barrier created by charged contamination. This gradual decrease of the pre-quadrupole DC offset with increasing contamination is configured to keep the kinetic energy of ions more or less constant during operation. This latter approach, however, requires more frequent calibrations (i.e. pre-quadrupole DC adjustments). This can be done by recording stopping curves of calibrant ions.

Thus, in some embodiments, the quadrupole mass filter is configured such that the DC offset applied to the secondary quadrupole segment 22 is decreased during operation. By lowering the DC offset of the pre-quadrupole 22, an increasing potential barrier created by the build-up over time of charged contamination layers can be counteracted.

The additional pre-quadrupole segment 22 allows the quadrupole mass filter to be operated in four modes of operation:
All segments 21, 22, 23, 24, 25 in RF-only mode;
The pre-quadrupole 22 with resolving DC voltages, the main quadrupole 24 in RF-only mode;
The pre-quadrupole 22 in RF-only mode, and the main quadrupole 24 with resolving DC voltages; and
The pre-quadrupole 22 and the main quadrupole 24 with resolving DC voltages.

To calibrate the 5S-quad, the amplitudes of the resolving DC and RF voltages should be adjusted, as well as the DC offsets for different transmission windows. The following calibration procedure can be used, keeping in mind that the pre-quadrupole 22 and the main quadrupole 24 will have roughly similar RF amplitudes.

1. Set the pre-quadrupole 22 in RF-only mode. Perform calibration of the main quadrupole 24 for different mass windows.

2. For different mass windows set the voltages of the main quadrupole 24 and gradually decrease the resolving DC applied to the pre-quadrupole 22 for maximum transmission of the 5S-Quad. As a result, resolving DCs of the pre-quadrupole 22 are obtained for different m/zs.

3. Adjust the DC offsets to get the required isolation windows shapes and good transmission.

4. Fine tune the resolving DCs (repeat steps 1, 2).

The 5S-Quad according to embodiments can be used in various mass spectrometers having a resolving quadrupole. Embodiments allow a considerably increase in service intervals between cleanings. For example, the m/z transmission width of the pre-quadrupole 22 in the 5S-Quad is narrower in comparison to the ion source filter described in U.S. Pat. No. 9,929,003 by about a factor of 10 for m/z 195 and 6 for m/z 1622. This factor can be taken as an estimation for the increase in the intervals between quadrupole cleaning cycles. This is expected to be in the range of 5-10.

Although the present invention has been described with reference to various embodiments, it will be understood that various changes may be made without departing from the scope of the invention as set out in the accompanying claims.

1. A quadrupole mass filter assembly comprising:
an entrance quadrupole segment, wherein the entrance quadrupole segment is configured to receive RF voltages;
a secondary quadrupole segment arranged downstream of the entrance quadrupole segment, wherein the secondary quadrupole segment is configured to receive RF and resolving DC voltages;
a middle quadrupole segment arranged downstream of the secondary quadrupole segment, wherein the middle quadrupole segment is configured to receive RF voltages;
a primary quadrupole segment arranged downstream of the middle quadrupole segment, wherein the primary quadrupole segment is configured to receive RF and resolving DC voltages; and
an end quadrupole segment arranged downstream of the primary quadrupole segment, wherein the end quadrupole segment is configured to receive RF voltages;
wherein the entrance quadrupole segment, the secondary quadrupole segment, the middle quadrupole segment, the primary quadrupole segment, and the end quadrupole segment are assembled together into a single assembly, and wherein each pair of adjacent quadrupole segments is spaced apart by a length less than or equal to 2 mm.

2. The assembly of claim 1, wherein the primary quadrupole segment has a first length, and the secondary quadrupole segment has a second length that is less than the first length.

3. The assembly of claim 2, wherein the first length is greater than or equal to 15r₀, where r₀ is an inscribed radius of the primary quadrupole segment.

4. The assembly of claim 2, wherein the second length is greater than or equal to 5r₀ and/or less than or equal to 10r₀.

5. The assembly of claim 2, wherein the middle quadrupole segment has a third length that is less than or equal to 5r₀.

6. The assembly of claim 5, wherein the third length is greater than or equal to 2r₀.

7. The assembly of claim 2, wherein:
the entrance quadrupole segment has a fourth length that is greater than or equal to 2r₀ and/or less than or equal to 5r₀, and/or
the end quadrupole segment has a fifth length that is greater than or equal to 2r₀ and/or less than or equal to 5r₀.

8. A quadrupole mass filter comprising:
the assembly of claim 1;
one or more RF voltage power supplies configured to supply RF voltages to the entrance quadrupole segment, the secondary quadrupole segment, the middle quadrupole segment, the primary quadrupole segment, and the end quadrupole segment; and
one or more DC voltage power supplies configured to supply resolving DC voltages to the primary quadrupole segment and to the secondary quadrupole segment.

9. The quadrupole mass filter of claim 8, wherein an amplitude of an RF voltage supplied to the middle quadrupole segment is between about 30% and 150% of an amplitude of an RF voltage supplied to the primary quadrupole segment.

10. The quadrupole mass filter of claim 8, wherein the primary quadrupole segment and the secondary quadrupole segment are supplied with RF voltages by the same single RF power supply.

11. The quadrupole mass filter of claim 8, comprising one or more DC voltage power supplies configured to supply respective DC offset voltages to the primary quadrupole segment and the secondary quadrupole segment.

12. The quadrupole mass filter of claim 11, wherein the quadrupole mass filter is configured to decrease a magnitude of a DC offset voltage applied to the secondary quadrupole segment during operation to maintain a kinetic energy of the ions as contamination of the secondary quadrupole segment produces an increasing potential barrier.

13. The quadrupole mass filter of claim 8, wherein the quadrupole mass filter is configured such that ions are received by the secondary quadrupole segment with a first average oscillation amplitude and are received by the primary quadrupole segment with a second average oscillation amplitude, wherein the second average oscillation amplitude is at least 1.15 times the first average oscillation amplitude.

14. An analytical instrument comprising:
an ion source configured to generate ions; and
the quadrupole mass filter of claim 8;
wherein the analytical instrument is configured such that the quadrupole mass filter receives at least some of the ions generated by the ion source and/or receives ions derived from ions generated by the ion source, and
wherein the quadrupole mass filter is configured to transmit at least some of the received ions.

15. A method of calibrating voltages to be applied to the quadrupole mass filter of claim 8, the method comprising:
(i) operating the secondary quadrupole segment in an RF-only mode and calibrating the primary quadrupole segment to obtain calibrated resolving DC voltage amplitudes and RF voltage amplitudes for the primary quadrupole segment for each of a plurality of different mass to charge ratio (m/z) transmission windows; and
(ii) obtaining suitable resolving DC voltage amplitudes for the secondary quadrupole segment for each of the plurality of different mass to charge ratio (m/z) transmission windows by:
for each mass to charge ratio (m/z) transmission window of some of all of the plurality of different mass to charge ratio (m/z) transmission windows: operating the primary quadrupole segment with the resolving DC voltage amplitude and RF voltage amplitude obtained from step (i) for that transmission window and adjusting the resolving DC voltage amplitude applied to the secondary quadrupole segment so as to increase ion transmission through the quadrupole mass filter.

16. The method of claim 15, further comprising:
(iii) adjusting DC offset voltage(s) applied to the primary quadrupole segment and/or to the secondary quadrupole segment to obtain suitable isolation window shapes and ion transmission; and then
(iv) repeating steps (i) and (ii) so as to fine tune the resolving DC voltage amplitudes.

17. A quadrupole mass filter comprising:
an entrance quadrupole segment, wherein the entrance quadrupole segment is configured to receive RF voltages;
a secondary quadrupole segment arranged downstream of the entrance quadrupole segment, wherein the secondary quadrupole segment is configured to receive RF and resolving DC voltages;
a middle quadrupole segment arranged downstream of the secondary quadrupole segment, wherein the middle quadrupole segment is configured to receive RF voltages;
a primary quadrupole segment arranged downstream of the middle quadrupole segment, wherein the primary quadrupole segment is configured to receive RF and resolving DC voltages;
an end quadrupole segment arranged downstream of the primary quadrupole segment, wherein the end quadrupole segment is configured to receive RF voltages;
one or more RF voltage power supplies configured to supply RF voltages to the entrance quadrupole segment, the secondary quadrupole segment, the middle quadrupole segment, the primary quadrupole segment, and the end quadrupole segment; and
one or more DC voltage power supplies configured to supply resolving DC voltages to the primary quadrupole segment and to the secondary quadrupole segment and to supply respective DC offset voltages to the primary quadrupole segment and the secondary quadrupole segment,
wherein the quadrupole mass filter is configured to decrease a magnitude of a DC offset voltage applied to the secondary quadrupole segment during operation to maintain a kinetic energy of the ions as contamination of the secondary quadrupole segment produces an increasing potential barrier.

18. A method of operating a quadrupole mass filter that comprises:
an entrance quadrupole segment, a secondary quadrupole segment arranged downstream of the entrance quadrupole segment, a middle quadrupole segment arranged downstream of the secondary quadrupole segment, a primary quadrupole segment arranged downstream of the middle quadrupole segment, and an end quadrupole segment arranged downstream of the primary quadrupole segment;
wherein the entrance quadrupole segment, the secondary quadrupole segment, the middle quadrupole segment, the primary quadrupole segment, and the end quadrupole segment are assembled together into a single assembly, and wherein each pair of adjacent quadrupole segments is spaced apart by a length less than or equal to 2 mm;
the method comprising:
applying RF voltages to the entrance quadrupole segment;
applying RF and resolving DC voltages to the secondary quadrupole segment;
applying RF voltages to the middle quadrupole segment;
applying RF and resolving DC voltages to the primary quadrupole segment; and
applying RF voltages to the end quadrupole segment.

19. The method of claim 18, wherein:
the primary quadrupole segment has a first length;
the secondary quadrupole segment has a second length that is less than the first length and that is greater than or equal to 5r₀, where r₀ is an inscribed radius of the primary quadrupole segment; and
the middle quadrupole segment has a third length that is less than or equal to 5r₀.

20. The method of claim 18, wherein an amplitude of the RF voltage applied to the middle quadrupole segment is between 30% and 150% of an amplitude of the RF voltage applied to the primary quadrupole segment.
